(19) United States
(12) Patent Application Publication
(10) Pub. No.: US 2005/0199108 A1
(43) Pub. Date: Sep. 15, 2005

(54) Wrench-attached screwdriver

(76) Inventor: Jin-Neng Jheng, Shu-Lin City (TW)

Correspondence Address: SUPREME PATENT SERVICES, POST OFFICE BOX 2339, SARATOGA, CA, 95070, US

(21) Appl. No.: 10/799,031

(22) Filed: Mar. 12, 2004

(51) Int. Cl. B25B 23/16

(52) U.S. Cl. 81/177.5

(57) ABSTRACT

A wrench-attached screwdriver is comprised of a screwdriver portion, a wrench portion, and a connection part, in which the connection part is arranged for connecting the screwdriver portion with the wrench portion and for relaying the torque of the wrench portion to the screwdriver portion. When a high torque is required to lock a screw tight, a user is supposed to first twist the screw to a critical point with the screwdriver portion, then pull an auxiliary wrench up to apply torque on the screw, and an inverse procedure is to be performed for unlocking the screw vice versa.

### BACKGROUND OF THE INVENTION

1. Field of the Invention

The present invention relates generally to screwdrivers, particularly to a wrench-attached screwdriver capable of providing rapid twist (function of a screwdriver) and high torque (function of a wrench) for improving the defect of insufficient torque of an average conventional screwdriver.

2. The Prior Arts

A common manipulative screwdriver is known defective in the following aspects:
(1) It can be rotated rapidly though, the torque thereof is insufficient to lock or unlock a screw.
(2) It requires more rotational pressure particularly in screwing a wood-screw, which is liable to cause an improper eccentric operation and has the screw escaped.
(3) When locking or unlocking a hexagonal or a hexagonal socket screw, a specified wrench has to be drawn out after rotating 90° every time before it can work continuously.

In view of the above, the present invention is intended to provide an improved screwdriver attached with wrench, which is merited in: (1) rapid twist with high torque; (2) a stationary center of grip sustainable when torque is applied; (3) being possible to sleeve-joint with different screws or nuts; (4) being possible for a wrench portion to rotate around a specified point or move up-and-down and rotate to dodge a work piece without being limited to a specified point; and (5) the wrench being integrated in a unity with the main shaft without occupying space too much.

### SUMMARY OF THE INVENTION

The primary object of the present invention is to provide a wrench-attached screwdriver capable of twisting rapidly and outputting high torque to eliminate the defects of a conventional screwdriver.

The wrench-attached screwdriver of the present invention is mainly comprised of a screwdriver portion, a wrench portion, and a connection part. The connection part is used to connect the screwdriver portion with the wrench portion and thereby relay the torque of the wrench portion to the screwdriver portion. The screwdriver portion further comprises a handgrip, a square main shaft, a sleeve coupling, and a screwdriver head, in which the front end of the square main shaft is connected with the sleeve coupling, which may cup-joint with the screwdriver head of various types; a groove is defined in a middle part of the square main shaft for retaining a buckle, which would serve as a positioner to allow the wrench portion to be duly positioned; and a cylindrical portion is defined at the rear end of the square main shaft. The connection part could be a ratchet component, or an insertion pin fixed to the main shaft, or a miscellaneous connection device to be cup-jointed with or fixed to the main shaft. The wrench portion is substantially an auxiliary wrench for torque output and is fixed tightly to the cylindrical portion of the main shaft through a buckling device (a spring leaf, for example) such that the auxiliary wrench can be integrated with the main shaft to form a unitary body that does not occupy too much space.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is a perspective view of a wrench-attached screwdriver of the present invention;

FIG. 2 is an exploded view of the wrench-attached screwdriver of the present invention;

FIG. 3 is a schematic view showing the state when the auxiliary wrench of a wrench-attached screwdriver of the present invention is pulled up;

FIG. 4 is a schematic view showing that the auxiliary wrench of the wrench-attached screwdriver of the present invention is applicable for twisting at a specified point or moving up and down and twisting at unspecified points;

FIG. 5 is a schematic view showing the action of a ratchet component of the wrench-attached screwdriver; and

FIG. 6 is a sectional view showing that the auxiliary wrench of the present invention is checked tightly on a cylindrical portion of a square main shaft.

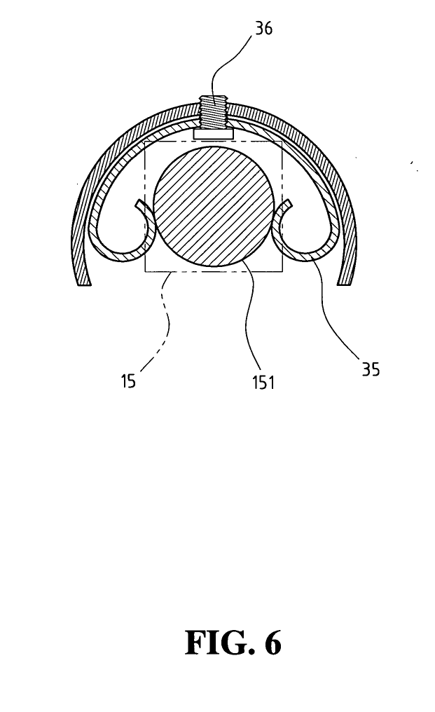

### DETAILED DESCRIPTION OF THE PREFERRED EMBODIMENT

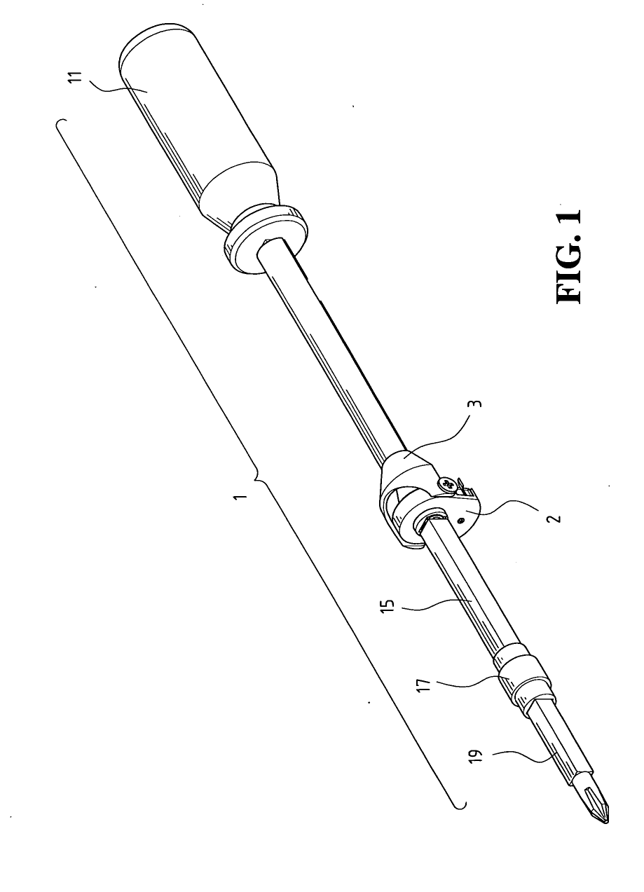

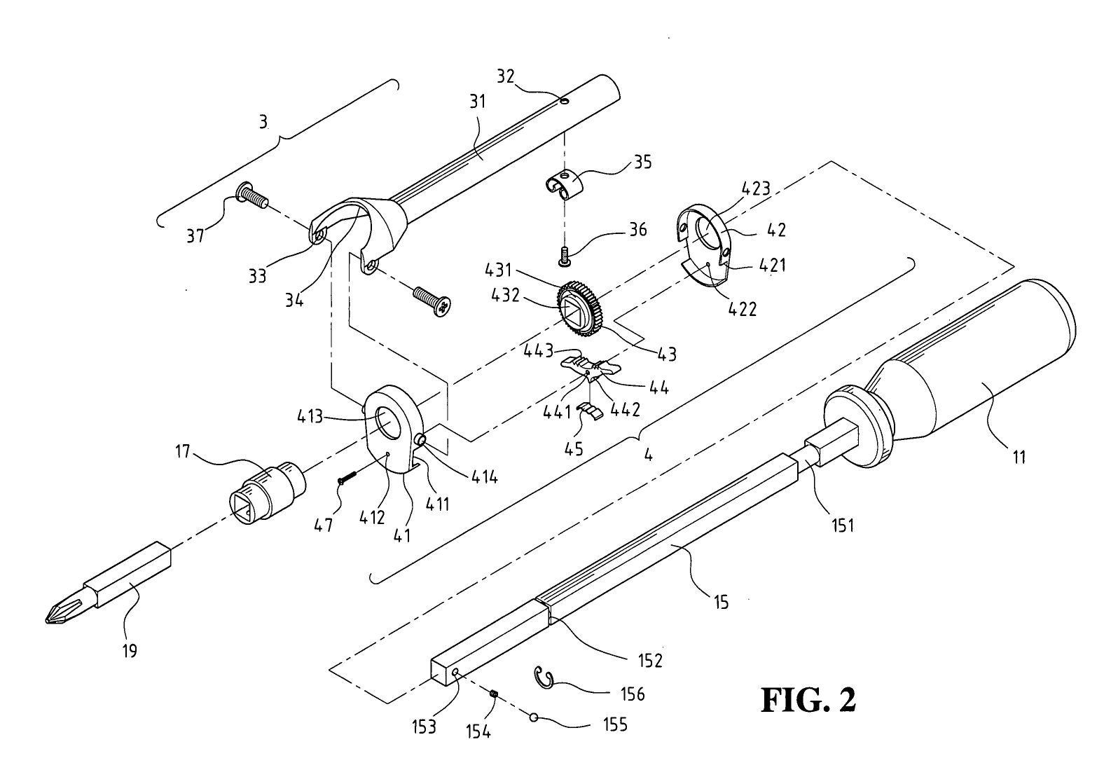

A wrench-attached screwdriver of the present invention according FIGS. 1 and 2 is comprised of a screwdriver portion 1, a wrench portion 3, and a connection part 2.

The connection part 2 is employed to connect with the screwdriver portion 1 and the wrench portion 3 to thereby relay the torque of the wrench portion 3 to the screwdriver portion 1. The screwdriver portion 1 further comprises a handgrip 11, a square main shaft 15, a sleeve coupling 17, and a screwdriver head 19, in which the front end of the square main shaft 15 is in connection with the sleeve coupling 17, which may cup-joint with the screwdriver head 19 of various types; a groove 152 is defined in a middle part of the square main shaft 15 for retaining a buckle 156, which would serve as a positioner to allow the wrench portion 3 to be duly positioned; and a cylindrical portion 151 is defined at the rear end of the square main shaft 15. The connection part 2 could be a ratchet component 4, or an insertion pin (not shown) fixed to the main shaft 15, or a miscellaneous connection device (not shown) to be cup-jointed with or fixed to the main shaft 15, in which a connection device cup-jointed with the main shaft 15 is movable up and down and twistable at undefined positions along the range between the buckle 156 in the middle part and the cylindrical portion 151 at the rear end of the main shaft 15. The wrench portion 3 is substantially an auxiliary wrench 31 for torque output and is fixed tightly to the cylindrical portion 151 of the main shaft 15 through a buckling device (a spring leaf 35 for example) such that the auxiliary wrench 31 can be integrated with the main shaft 15 to form a unitary body that doesn't occupy too much space.

A ball cavity 153 for accommodating a spring 154 and a steel ball 155 is arranged at the front end of the main shaft 15, in which the steel ball 155 is supposed to check the sleeve coupling 17, which is designed to cup-joint with the screwdriver head 19 of various types, such as a slotted screwdriver, phillips screwdriver, nut driver, and hexagonal socket screw.

The ratchet component 4 provided to relay the torque applied by the auxiliary wrench 31 to the screwdriver portion 1 comprises an upper cover 42, a ratchet 43, a lower cover 41, a forward/backward rotation control piece 44, and a corrugated spring leaf 45. The upper cover 42 and the lower cover 41 are combined to form a box for receiving the ratchet 43, the forward/backward rotation control piece 44, and the corrugated spring leaf 45. A circular flange 431 is defined on each central portion of an upper and a lower surface of the ratchet 43 respectively for combining the upper cover 42 and the lower cover 41 together, and a square hole 432 is formed centrally in the circular flange 431 to allow the main shaft 15 to penetrate therethrough. The outer edge of the ratchet 43 is a serrate structure. In the upper cover 42 and the lower cover 41, a circular hole 423/413 is defined respectively for matching with the flange 431, in which a hole 422/412 is arranged below respective circular holes 423/413 for installation of the forward/backward rotation control piece 44 by an insertion pin 47. Each cover has a gap 421/411 formed on the right and the left side thereof respectively to allow two ends of the forward/backward rotation control piece 44 to extend outwardly through those gaps to facilitate the forward/backward rotation control operation of the ratchet. Moreover, a protruding screw hole 414 is provided to the lower cover 41 on both sides thereof for combining with the auxiliary wrench 31. The corrugated spring leaf 45 is fixed inside the lower cover 41. The forward/backward rotation control piece 44 has a central hole 441 for the insertion pin 47 to fix the forward/backward rotation control piece 44 on the upper cover 42 and the lower cover 41. Both the right side and the left side of the upper edge of the forward/backward rotation control piece 44 have a serration 443 for engaging with the serrate structure on the outer edge of the ratchet 43, while the lower edge of the forward/backward rotation control piece 44 has a protruding block 442 to sustain the corrugated spring leaf 45 and control forward/backward rotation of the ratchet 43 based on the lever principle. The front end of the auxiliary wrench 31 is formed with a tiger's mouth 34, the depth of which must be deep enough to dodge an upper edge of ratchet component 4, and a circular hole 33 is disposed on both sides of the tiger's mouth 34 to enable the auxiliary wrench 31 to be locked together with the ratchet component 4 by a screw 37.

The detailed configuration and operation of the present invention will be described below.

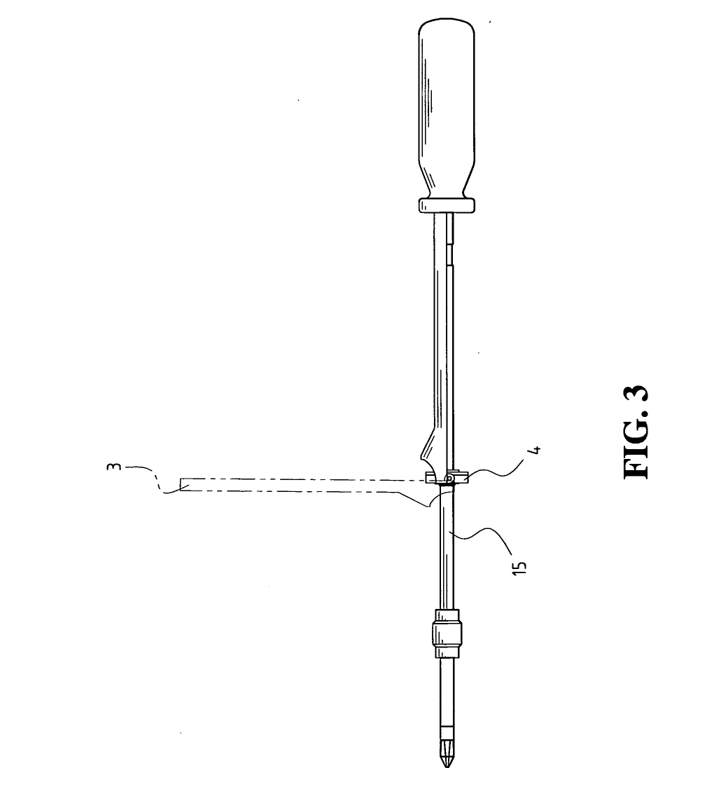

As illustrated in FIGS. 1 and 2, after assembling, the ratchet component 4 is positioned at the buckle 156 retained in the groove 152 of the main shaft 15, and the auxiliary wrench 31 is checked tightly onto the cylindrical portion 151 of the main shaft 15 by assistance of the spring leaf 35, where the rear end the auxiliary wrench 31 is intimately jointed with the handgrip 11 and where the auxiliary wrench 31 itself is integrated with the main shaft 15 to form a unitary body without occupying too much space. In case a high torque is required to lock a screw tight, a user is supposed to first twist the screw to a critical point with the screwdriver portion, then pull the auxiliary wrench 31 (referring to FIG. 3) up to apply torque on the screw. An inverse procedure is suggested when a high torque is needed for dismounting a screw.

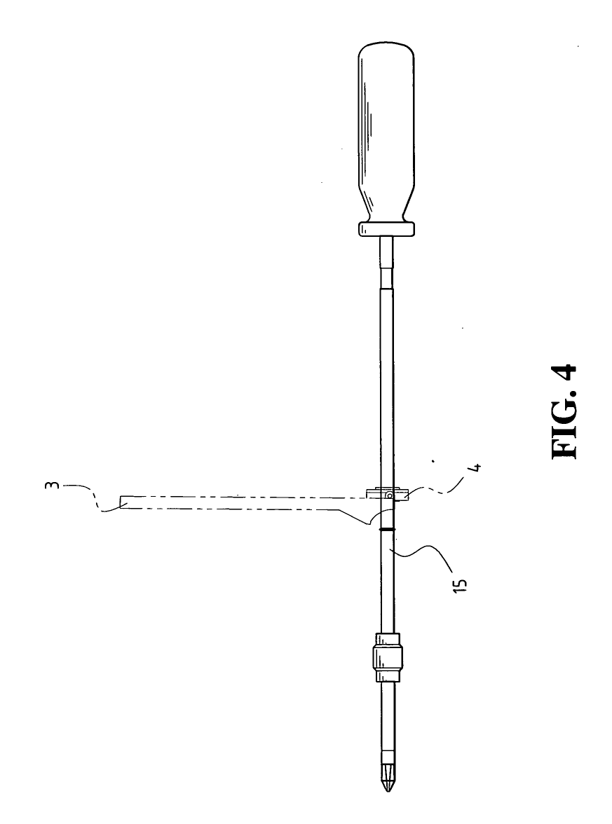

FIG. 4 is a schematic view showing that the auxiliary wrench of the wrench-attached screwdriver of the present invention is applicable for twisting at a specified point or moving up and down and twisting at unspecified points to dodge an obstacle.

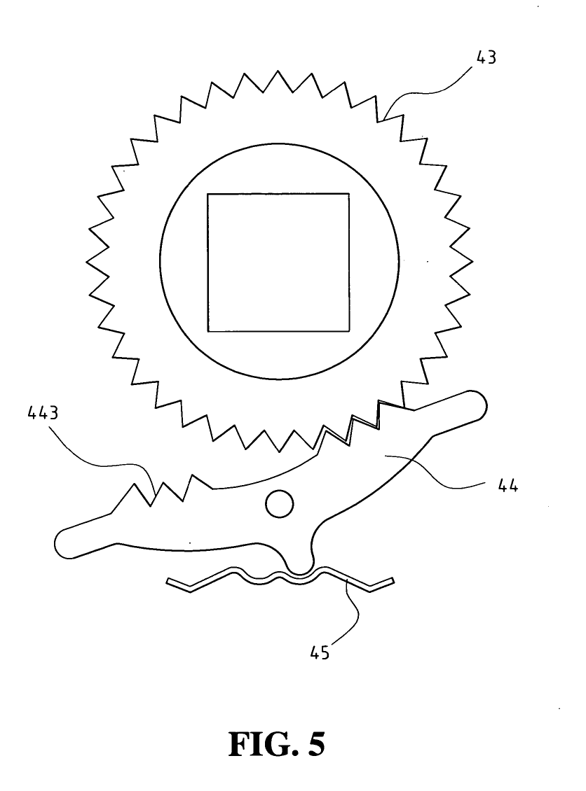

FIG. 5 is a schematic view showing the action of a ratchet component of the wrench-attached screwdriver, applied in the counterclockwise direction. As shown in this figure, the auxiliary wrench 31 could be rotated counterclockwise to drive the ratchet component 4 to rotate in the same direction to thereby transmit torque to the main shaft 15 (see FIG. 3). In the case of clockwise application, the left side serration 443 on the upper edge of the forward/backward rotation control piece 44 should be engaged with the outer edge serrate structure of the ratchet 43 to thereby obtain the required torque for rotation in the clockwise direction.

In the above described, at least one preferred embodiment has been described in detail with reference to the drawings annexed, and it is apparent that numerous changes or modifications may be made without departing from the true spirit and scope thereof, as set forth in the claims below.

1. A wrench-attached screwdriver, comprising a screwdriver portion, a wrench portion, and a connection part, in which the connection part is used to connect the screwdriver portion with the wrench portion and thereby relay the torque of the wrench portion to the screwdriver portion.

2. The wrench-attached screwdriver according to claim 1, wherein the screwdriver portion comprises a handgrip, a square main shaft, a sleeve coupling, and a screwdriver head, in which a front end of the square main shaft is connected with the sleeve coupling, which may cup-joint with the screwdriver head of various types; a groove is defined in a middle part of the square main shaft for retaining a buckle, which would serve as a positioner to allow the wrench portion to be duly positioned; and a cylindrical portion is defined at the rear end of the square main shaft.

3. The wrench-attached screwdriver according to claim 2, wherein the connection part is a ratchet component cup-jointed with the square main shaft.

4. The wrench-attached screwdriver according to claim 2, wherein the connection part is an insertion pin fixed at the main shaft.

5. The wrench-attached screwdriver according to claim 2, wherein the wrench portion is substantially an auxiliary wrench for torque output and is fixed tightly to the cylindrical portion of the main shaft through a buckling device (a spring leaf, for example) such that the auxiliary wrench can be integrated with the main shaft to form a unitary body that doesn't occupy too much space.

6. The wrench-attached screwdriver according to claim 3, wherein the ratchet component cup-jointed with the main shaft is movable up and down and twistable at undefined positions along the range between the buckle in the middle part and the cylindrical portion at the rear end of the main shaft.

7. The wrench-attached screwdriver according to claim 3, wherein the ratchet component further comprises an upper cover, a ratchet, a lower cover, a forward/backward rotation control piece, and a corrugated spring leaf, in which the upper cover and the lower cover are combined to form a box for receiving the ratchet, the forward/backward rotation control piece, and the corrugated spring leaf.

8. The wrench-attached screwdriver according to claim 7, wherein a circular flange is defined on each central portion of an upper and a lower surface of the ratchet respectively for combining the upper cover and the lower cover together; a square hole is formed centrally in the circular flange to allow the main shaft to penetrate therethrough; and a serrate structure is formed on an outer edge of the ratchet.

9. The wrench-attached screwdriver according to claim 7, wherein the forward/backward rotation control piece has a central hole for the insertion pin to fix the forward/backward rotation control piece on the upper cover and the lower cover; both the right side and the left side of the upper edge of the forward/backward rotation control piece have a serration for engaging with the serrate structure on the outer edge of the ratchet, while the lower edge of the forward/backward rotation control piece has a protruding block to sustain the corrugated spring leaf.

10. The wrench-attached screwdriver according to claim 7, wherein a circular hole is defined respectively in the upper cover and the lower cover for matching with the flange, in which a hole is arranged below respective circular holes for installation of the forward/backward rotation control piece by an insertion pin; and the each cover has a gap formed on the right and the left side thereof respectively to allow two ends of the forward/backward rotation control piece to extend outwardly through those gaps to facilitate the forward/backward rotation control operation of the ratchet.
